(19) United States
(12) Patent Application Publication
(10) Pub. No.: US 2018/0182567 A1
(43) Pub. Date: Jun. 28, 2018

(54) A CONTACT SYSTEM IN A LOW-VOLTAGE SWITCH AND A LOW-VOLTAGE SWITCH

(71) Applicant: BEIJING PEOPLE'S ELECTRIC PLANT CO., LTD., Beijing (CN)

(72) Inventors: Yin NAN, Beijing (CN); Jinbao ZHU, Beijing (CN); Jinying LI, Beijing (CN); Kanyuan LIU, Beijing (CN)

(73) Assignee: BEIJING PEOPLE'S ELECTRIC PLANT CO., LTD., Beijing (CN)

(21) Appl. No.: 15/739,106

(22) PCT Filed: Nov. 5, 2015
(86) PCT No.: PCT/CN2015/093893

§ 371 Date: Dec. 21, 2017

(30) Foreign Application Priority Data
Aug. 6, 2015 (CN) 201510478109.0

(51) Int. Cl. H01H 1/06; H01H 1/58; H01H 1/50; H01H 1/20; H01H 1/22

(52) U.S. Cl. CPC H01H 1/06; H01H 1/5833; H01H 1/50; H01H 2001/223; H01H 1/221; H01H 2235/01; H01H 1/2041

(57) ABSTRACT

A contact system in a low-voltage switch and a low-voltage switch are provided. The contact system comprises a bifurcated contact and a movable contact. The bifurcated contact has an upper bifurcated end and a lower bifurcated end. Electrical contact portions are respectively arranged on insides of the upper bifurcated end and the lower bifurcated end. Electrical contact portions are respectively arranged on upper and lower surfaces of an execution end of the movable contact corresponding to the electrical contact portions of the bifurcated contact. When the contact system is switched on and powered up, electrodynamic repulsion forces produced at the electrical contact portions of the bifurcated contact are offset, so that the contact system can stably maintain an ON state, thereby improving a short-time current withstand capability of a low-voltage switch using the contact system. (FIG. 1)

### CROSS-REFERENCE TO RELATED APPLICATIONS

This application is a National Stage of International Application No. PCT/CN2015/093893, filed on Nov. 5, 2015, which claims priority to Chinese Patent Application No. 201510478109.0, filed on Aug. 6, 2015, both of which are hereby incorporated by reference in their entireties.

### TECHNICAL FIELD

The present disclosure relates to the electric field, and more particularly, to a contact system in a low-voltage switch and a low-voltage switch.

### BACKGROUND

As an important component of low-voltage electric appliances, switches have an important performance index which is the short-time current withstand capability. Most of the existing low-voltage switches, such as Class B circuit breakers, disconnecting bodys, have a certain short-time current withstand capability, but they sometimes fail to meet the high demand for the short-time current withstand capability in some application scenarios such as dual power conversion systems.

The contact system is the core part of the low-voltage switch, usually including a movable contact and a fixed contact, and the low-voltage switch is on/off when the movable contact is connected / disconnected to the fixed contact. In order to improve short-time current withstand capability of the low-voltage switch, the existing practice is to modify the fixed contact from a repulsion force structure to a no repulsion force structure, while increasing the final pressure of the removable contact. However, this practice cannot significantly improve the short-time current withstand capability of the low-voltage switch due to the presence of electrodynamic force at the electrical contact portions of the movable contact and the fixed contact in the contact system. Moreover, increasing the final pressure of the movable contact will result in a strong increase in the local strength of the rotating shaft used to hold the movable contact, which places a higher demand for the material, structure, process, and accommodation of the shaft, difficulty on design and production is increased significantly.

### SUMMARY

In view of the above-mentioned problems, the present disclosure provides a contact system in a low-voltage switch and a low-voltage switch.

According to an embodiment of the present disclosure, a contact system comprises a bifurcated contact and a movable contact, wherein the bifurcated contact has an upper bifurcated end and a lower bifurcated end, wherein electrical contact portions are respectively arranged on insides of the upper bifurcated end and the lower bifurcated end, electrical contact portions are respectively arranged on upper and lower surfaces of an execution end of the movable contact corresponding to the electrical contact portions of the bifurcated contact, when the contact system is switched on and powered up, electrodynamic repulsion forces produced at the electrical contact portions of the bifurcated contact are offset, so that the contact system can stably maintain an ON state.

According to an embodiment of the present disclosure, a low-voltage switch comprises an arc-extinguishing chamber, an operating mechanism and a contact system described above.

A series of simplified concepts are introduced in the Summary section of the disclosure, which will be described in further detail in the Detailed Description section. The present disclosure is not intended to limit the critical features and essential technical features of the claimed solutions, and is not intended to determine the scope of protection of the claimed technical solution.

The advantages and features of the present disclosure will be described in detail below with reference to the accompanying drawings.

### BRIEF DESCRIPTION OF THE DRAWINGS

The following drawings of the present application are hereby incorporated as part of the present application for illustration. The embodiments shown in the drawings and description are used to explain the principles of the disclosure. In the drawings:

FIG. 1 is a sectional structure diagram of a low-voltage switch according to an exemplary embodiment of the present disclosure;

FIG. 2 is a structure diagram of a bifurcated contact according to a first exemplary embodiment of the present disclosure;

FIG. 3 is a structure diagram of a bifurcated contact according to a second exemplary embodiment of the present disclosure;

FIG. 4 is an assembly diagram of the bifurcated contact shown in FIG. 2 in a low-voltage switch;

FIG. 5 is an assembly diagram of the bifurcated contact shown in FIG. 3 in a low-voltage switch;

FIG. 6 is a structure diagram of a removal contact according to an exemplary embodiment of the present disclosure;

FIG. 7 is a assembly sectional diagram of the removal contact shown in FIG. 6 and a rotating shaft;

FIG. 8 is a structure diagram of a contact system according to a first exemplary embodiment of the present disclosure;

FIG. 9 is a structure diagram of a contact system according to a second exemplary embodiment of the present disclosure;

FIG. 10 is a force analysis diagram of the contact system in the second exemplary embodiment shown in FIG. 9 and in the ON state; and

FIG. 11 is a schematic diagram of a contact system in the ON state according to a third exemplary embodiment of the present disclosure.

### DETAILED DESCRIPTION

The exemplary embodiments and features of the various aspects of the present disclosure will be described in detail below. In the following detailed description, numerous specific details are set forth in order to provide a thorough understanding of the present disclosure. It will be apparent, however, to one skilled in the art that the present disclosure may be practiced without the need for some of the details in these specific details. The following description of the embodiments is merely for the purpose of providing a better understanding of the present disclosure by showing examples of the present disclosure. The present disclosure is by no means limited to any of the specific configurations and algorithms set forth below, but is intended to cover any modifications, substitutions, and improvements of elements, components and algorithms without departing from the spirit of the disclosure. In the drawings and the following description, well-known structures and techniques are not shown in order to avoid unnecessarily obscuring the present disclosure.

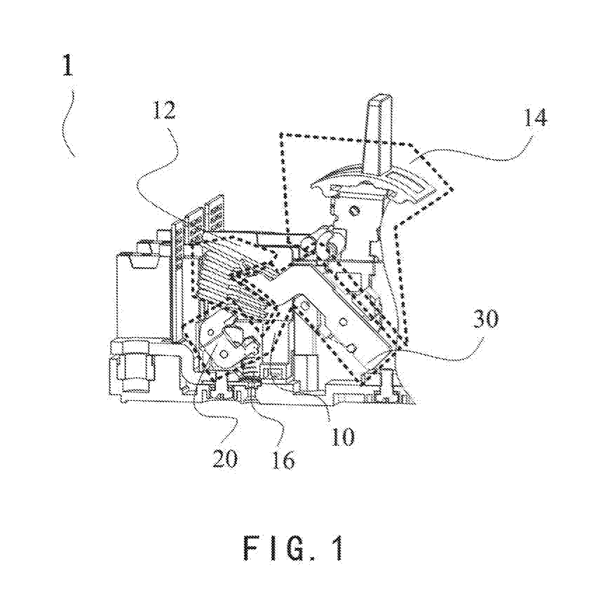

FIG. 1 shows a sectional structure diagram of a low-voltage switch according to an embodiment of the present disclosure. As shown in FIG. 1, the low voltage switch 1 mainly comprises a contact system 10, an arc extinguishing chamber 12, and an operating mechanism 14, wherein the contact system 10 includes a bifurcated contact 20 and a movable contact 30.

In the low-voltage switch 1 shown in FIG. 1, the switching on and off of the low-voltage switch 1 is controlled by controlling the connecting and disconnecting of the bifurcated contact 20 and the movable contact 30, and the connecting and disconnecting of the bifurcated contact 20 and the movable contact 30 is controlled by the operations of the operating mechanism 14. An electric arc generated during the process of disconnecting the bifurcated contact 20 with the movable contact 30 is introduced into the arc extinguishing chamber 12, so as to extinguish the electric arc finally using the arc extinguishing chamber 12.

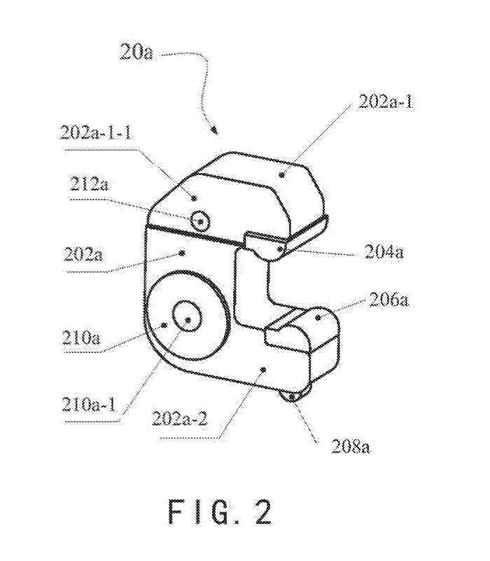

FIG. 2 shows a structure diagram of the bifurcated contact according to a first embodiment of the present disclosure. As shown in FIG. 2, the bifurcated contact 20a includes a U-shaped connecter 202a and two electrical contact portions 204a and 206a located inside the two bifurcated ends 202a-1 and 202a-2 of the U-shaped connecting body 202a (also referred as an upper bifurcated end and a lower bifurcated end below), respectively. In the present embodiment, grooves 202a-1-1 are provided on both sides of the upper bifurcated end 202a-1 of the U-shaped connecting body 202a, so the thickness of the upper bifurcated end 202a-1 is less than that of the lower bifurcated end 202a-2 of the U-shaped connecting body. The electrical contact portions 204a and 206a are of low contact resistance and are formed of electric arc-resistant material and the outer surfaces thereof facing each other may be designed to be arc-surface partly or completely (although the outer surfaces of the electrical contact portions 204a and 206a shown in FIG. 2 facing each other are set to a partial arc surface). In addition to being used for electrical contact, the arc surface design of the opposing outer surfaces of the electrical contact portions 204a and 206a is also used for making space during the process of connecting or disconnecting the bifurcated contact 20a with the movable contact 30. The electrical contact portions 204a and 206a may be connected to the respective inside surfaces of the two bifurcated ends 202a-1 and 202a-2 of the U-shaped connecting body 202a by means of welding, screw connection, rivet connection, etc.

As shown in FIG. 2, the U-shaped connecting body 202a is also arranged with a rotating hole 210a-1, and the U-shaped connecting body 202a is mounted on a mounting bracket by a mounting shaft through the rotating hole 210a-1 (the center of the rotating hole 210a acts as the rotating center of the bifurcated contact 20a). The rotating hole 210a-1 may be disposed at the center-down position of the bifurcated contact 20a in order to reliably separate the bifurcated contact 20a from the movable contact 30 during the disconnecting process. In addition, the position of the rotating hole 210a-1 on the bifurcated contact 20a determines the position where the current flows into or out of the bifurcated contact 20a when the bifurcated contact 20a is connected with the movable contact 30 (i.e., the rotating hole 210a-1 is the current inflow point or outflow point on the bifurcated contact 20a). On both sides of the U-shaped connecting body 202a, a circular boss 210a is provided outside the rotating hole 210a-1. When the bifurcated contact 20a is mounted to the low voltage switch through the mounting bracket, the mounting bracket has a clamping force on the circular bosses 210a on both sides of the U-shaped connecting body 202a, and during the rotation of the bifurcated contact 20a, the circular bosses 210a can reduce frictional forces. In addition, the circular boss 210a can also be used to improve the conductive condition between the bifurcated contact 20a and the mounting bracket and to keep the contact resistance between the bifurcated contact 20a and the mounting bracket stable when the bifurcated contact 20a rotates.

In addition, the bifurcated contact 20a is arranged with a restoration structure and is restored with the assistance of a spring or slips. Specifically, as shown in FIG. 2, a positioning hole 212a is arranged in the U-shaped connecting body 202a of the bifurcated contact 20a, and a protrusion 208a is arranged on the outer side of the lower bifurcated end 202a-2 of the U-shaped connecting body 202a for positioning of the restoring spring or clips 16, so as to restricting the bifurcated contact 20a.

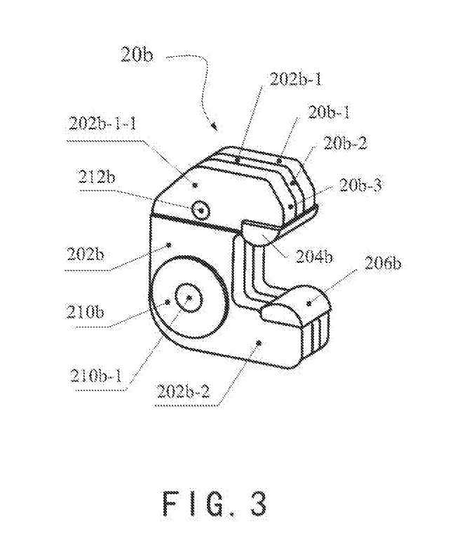

FIG. 3 shows a structural schematic diagram of a bifurcated contact according to a second embodiment of the present disclosure. As shown in FIG. 3, the bifurcated contact 20b includes a U-shaped connecting body 202b and two electrical contact portions 204b and 206b arranged inside the two bifurcated ends 202b-1 and 202b-2 of the U-shaped connecting body 202b, respectively. The U-shaped connecting body 202b may comprise three U-shaped connecting pieces 20b-1, 20b-2, and 20b-3 which are combined in the thickness direction, wherein the U-shaped connecting piece 20b-2 is interposed between the U-shaped connecting pieces 20b-1 and 20b-3. The U-shaped connecting pieces 20b-1 and 20b-3 on both sides have respective grooves 202b-1-1 thereon and have the same material (for example, copper), and the U-shaped connecting piece 20b-2 in the middle is a U-shaped connecting piece of equal thickness and its material (e.g., stainless steel) has a higher elasticity modulus than the U-shaped connecting pieces 20b-1 and 20b-3 on both sides thereof. The outer surfaces of the electrical contact portions 204b and 206b facing each other are all arc surfaces and the electrical contact portions 204b and 206b may be connected to the inside surfaces of the two bifurcated ends 202b-1 and 202b-2 of the U-shaped connecting body 202b by welding, screw connection, rivet connection, etc.

As shown in FIG. 3, a rotating hole 210b-1 is arranged below the center of the bifurcated contact 20b, and a positioning hole 212b is arranged above the rotating hole 210b-1, and the a circular boss 210b is arranged outside the rotating holes 210b-1 on both sides of the U-shaped connecting body 202b. It should be noted that the functions of the rotating hole 210b-1, the circular boss 210b, and the positioning hole 212b shown in FIG. 3 are similar to the corresponding portions in FIG. 2, which will not be repeated herein.

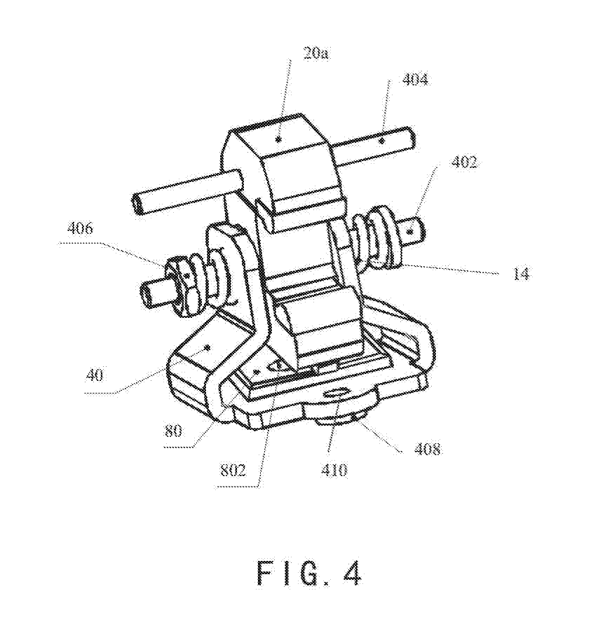

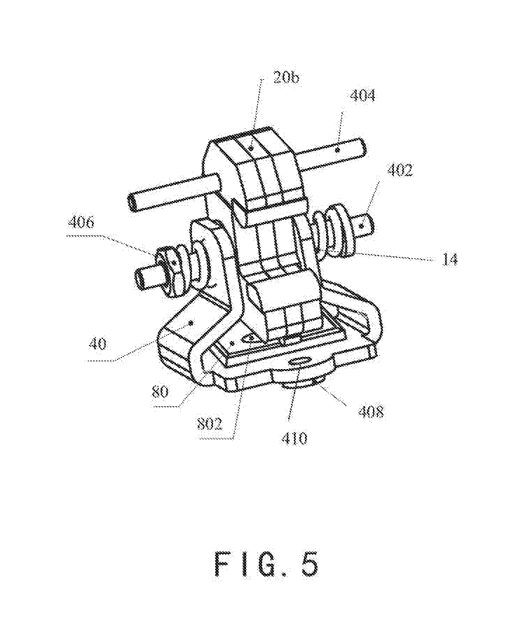

FIG. 4 shows an assembly diagram of the bifurcated contact shown in FIG. 2 in a low voltage switch. FIG. 5 shows an assembly diagram of the bifurcated contact shown in FIG. 3 in a low voltage switch. As shown in FIGS. 4 and 5, the rotating shaft 402 passes through the rotating hole 210a-1/210b-1 of the bifurcated contact 20a/20b to make the bifurcated contact 20a/20b in the middle of the bracket 40, such that the bifurcated contacts 20a/20b are fixed in the U-shaped groove inside the housing chamber of the low voltage switch 1. Adjustment devices 406 on both sides of the bracket 40 ensure that the contact pressure of the bracket 40 with the bifurcated contacts 20a/20b is stable and meets the temperature rise requirement. The hole of the bracket 40 engaged with the rotating shaft 402 is in clearance fit with the rotation shaft 402 in consideration of the influence of the manufacturing error, which is used to reduce the influence on the fixed positions of the bifurcated contact 20a/20b and the movable contact 30.

As shown in FIGS. 4 and 5, the bracket 40 and a connecting plate 80 located on the inner side of the bottom surface of the bracket 40 are arranged with holes 802 having the same upper and lower apertures. The bracket 40 is connected to the connecting plate 80 by a screw through the holes 802, and their effective contact area is ensured while meeting the temperature rise requirements. The bottom surface of the bracket 40 is arranged with a hole 410 at the front end thereof, and the bracket 40 is connected to the housing of the low voltage switch 1 by a screw through the hole 410. The boss 408 near the hole 410 at the front end of the bottom surface is used for positioning of the bracket 40 in the housing of the low voltage switch 1.

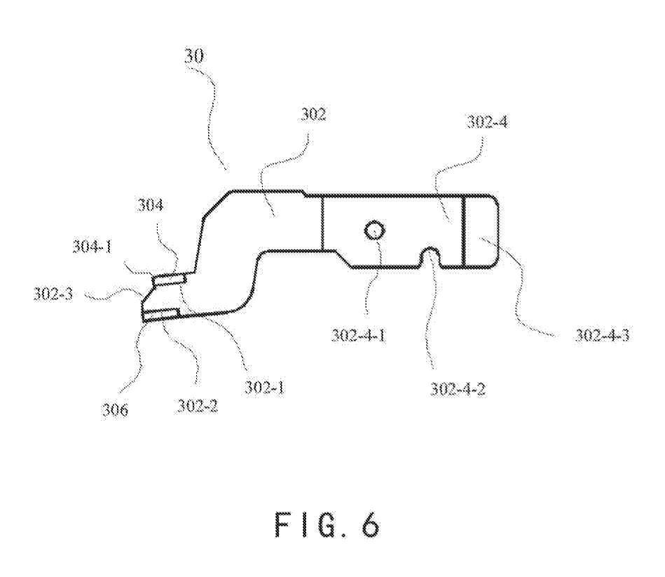

FIG. 6 shows a structure diagram of a movable contact according to an embodiment of the present disclosure. As shown in FIG. 6, the movable contact 30 includes an inverted Z-shaped connecting body 302 and electrical contact portions 304 and 306 on an upper plane 302-1 and a lower plane 302-2 of the duckbill-shaped projection of the execution end of the inverted Z-shaped connecting body 302, respectively. Since a slope 302-3 for making space is present on the execution end of the movable contact 30, the electrical contact portions 304 and 306 are staggered forward and backward. In addition, the edge of the electrical contact portion 304 is removed the sharp corner and may be arranged with a circular arc shape 304-1 so as to avoid the motion interference of the bifurcated contact 20 and the movable contact 30 during their transition in the switched on and off states. In addition, the rotating center hole 302-4-1 and a U-shaped groove 302-4-2 are provided on the rod portion 302-4 of the movable contact 30.

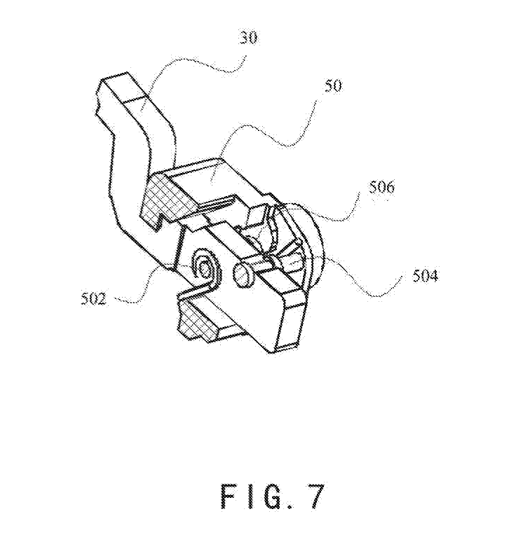

FIG. 7 shows an assembly sectional diagram of the movable contact shown in FIG. 6 and a rotating shaft. As shown in FIG. 7, the spring 506 for providing the final pressure for the movable contact 30 assembles the movable contact 30 and the rotating shaft 50 together with the assistance of a double shoulder shaft 504 assembled in the U-shaped groove 302-4-2 of the movable contact 30 and a shaft 502 passing through the rotating center hole 302-4-1 of the movable contact 30.

Specifically, as shown in FIGS. 6 and 7, the spring 506 for providing the final pressure for the movable contact 30 is mounted on the shaft 502 passing through the rotating center hole 302-4-1 of the movable contact 30. The U-bend side surface of the spring 506 cooperates with the shaft 502, and the two long arms act on the double shoulder shaft 504 assembled in the U-shaped groove 302-4-1 of the movable contact 30. The movable contact 30 rotates about the shaft 502 passing through the rotating center hole 302-4-1 and its rotation center coincides with the center of the shaft 502 passing through the rotating center hole 302-4-1. The advantage of this center coincidence is that it is possible to ensure the uniqueness of the fixed position between the movable contact 30 and the bifurcated contact 20 when they are connected. By the action of the spring 506 to the shoulder 214, there is still a good electric contact between the bifurcated contact 20 and the movable contact 30 when they are in the ON state. Even if the electrical contacts of the bifurcated contact 20 and/or the movable contact 30 has burning loss. In addition, a groove 302-4-3 is provided on the rod portion 302-4 of the movable contact 30, which is used for welding positioning of flexible wires.

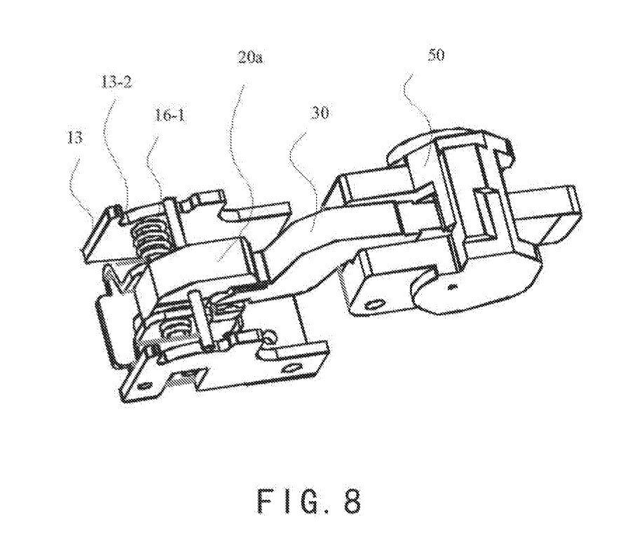

FIG. 8 shows a schematic structure diagram of a contact system (including the bifurcated contact 20a shown in FIG. 2 and the movable contact 30 shown in FIG. 6) according to a first embodiment of the present disclosure. The restoration principle of the bifurcated contact 20a shown in FIG. 2 will be described with reference to FIGS. 1, 4 and 8. Specifically, a screw through the hole 410 on the bottom surface of the bracket 40 connecting the bracket 40 to the housing of the low voltage switch has a part above the bracket floor used for positioning the restoring spring or clips 16 (see FIG. 1). When the bifurcated contact 20a is disconnected from the movable contact 30, the bifurcated contact 20a is rotated counterclockwise under the action of the movable contact 30 to reach a position completely separated from the movable contact 30. The bifurcated contact 20a continues to rotate counterclockwise by the spring force of the restoring spring/clips 16 (see FIG. 1) until the bifurcated contact 20a is stopped at the inside of projections 13-2 of the large bracket 13 with the position restrictions of the projections 13-2 of the large bracket 13 to the shaft 404 passing through the positioning hole 212a, so as to prepare for the next connection with the movable contact 30. The restoring spring/clips 16 serves to allow the bifurcated contact 20a to continue to rotate for making space. The angle of the bifurcated contact 20a at the stop position causes the electrical contact portion 306 of the movable contact 30 to contact with the electrical contact portion 206a of the bifurcated contact 20a at first during the switching on process, so that the bifurcated contact 20a and the movable contact 30 can be successfully connected. If there is no the restoring spring/clips 16 (see FIG. 1), the bifurcated contact 20a will remain in a position completely separated from the movable contact 30, and the electrical contact portion 306 of the movable contact 30 may first contact with the upper bifurcated end 202a-1 of the bifurcated contact 20a during the next switching on process, which causes the wear of the outer surfaces of the electrical contact portion 306 of the movable contact 30 and the upper bifurcated end 202a-1 of the bifurcated contact 20a or causes the bifurcated contact and the movable contact unable to be connected.

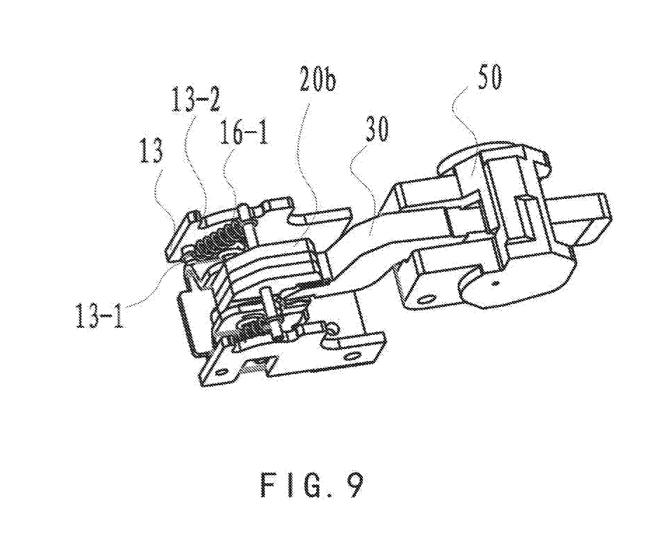

FIG. 9 shows a schematic structure diagram of a contact system (including the bifurcated contact 20b shown in FIG. 3 and the movable contact 30 shown in FIG. 6) according to the second embodiment of the present disclosure. The restoration principle of the bifurcated contact 20b will be described below with reference to FIGS. 5 and 9. One end of the restoring spring is connected to the positioning shaft 404 and the other end is connected to the projection 13-1 of the large bracket 13. When the contact system is switched on, the restoring springs are extended and the tension to the bifurcated contact 20b at the positioning hole 212b is along the axis direction of the springs. When the bifurcated contact 20b is disconnected with the movable contact 30, the bifurcated contact 20b is rotated counterclockwise under the actions of the movable contact 30 and the restoring springs until the bifurcated contact 20b is stopped at the inside of projections 13-1 of the large bracket 13 finally with the position restrictions of the projections 13-2 of the large bracket 13 to the shaft 404 passing through the positioning hole 212b, so as to prepare for the next connection with the movable contact 30.

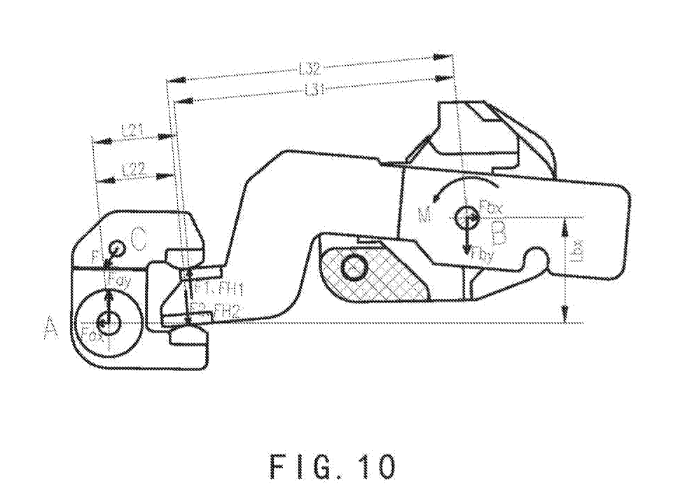

FIG. 10 shows a schematic diagram of the force analysis of the contact system shown in FIG. 9 in the ON state. F1 is the initial pressure of the electrical contact portion 304 of the movable contact 30 to the electrical contact portion 204b of the bifurcated contact 20b in the ON state, and F2 is the initial pressure of the electrical contact portion 306 of the movable contact 30 to the electrical contact portion 206b of the bifurcated contact 20b in the ON state. After powered up, the total current I will be distributed at the rotating center 210b-1 (A) of the bifurcated contact 20b. The current flowing through the upper bifurcated end 202b-1 of the bifurcated contact 20b and the electrical contact portion 204b inside the upper bifurcated end 202b-1 is defined as I₁, and the current flowing through the lower bifurcated end 202b-2 of the bifurcated contact 20b and the electrical contact portion 206b inside the lower bifurcated end 202b-2 is I₂. The Holm electric-dynamic repulsion force is generated between the upper and lower contacts of the electrical contact portions of the bifurcated contact 20b and the movable contact 30 due to current contraction, and FH1 is the Holm force on electrical contact portion 204b inside the upper bifurcated end 202b-1 of the bifurcated contact 20b and FH2 is the Holm force on the electrical contact portion 206b inside the lower bifurcated end 202b-2 of the bifurcated contact 20b. As shown in FIG. 10, F1, FH1, F2, and FH2 are perpendicular to the arc surfaces of the electrical contact portions 204b, 206b inside the two bifurcated ends of the bifurcated contact 20b, respectively, and point to their respective arc centers in opposite directions. The force F at the positioning hole 212b (C) of the bifurcated contact 20b is the pulling force of the restoring spring to the bifurcated contact 20b, M is the torque of the movable contact 30 provided by the final pressure spring 506, Fax, Fay is the reaction force of the bifurcated contact 20b at its rotation center hole 210b-1, and Fbx, Fby is the reaction force of the movable contact 30 at its rotation center hole 302-4-1 (B).

In the ON state, the initial pressure F1, F2 on the electrical contact portions 204b and 206b inside the two bifurcated ends 202b-1 and 202b-2 of the bifurcated contact 20b can be obtained based on the force and torque balance equations of the contact system. After powered up, the pressures on the electrical contact portions 204b and 206b at the two bifurcated ends 202b-1 and 202b-2 of the bifurcated contact 20b are changed to F1′ and F2′ under the two repulsion forces of the Holm force and the Lorentz force. The magnitude of the current directly affects the Holm force and the Lorentz force.

After powered up, the bifurcated contact 20b has a counterclockwise rotation tendency (i.e., in the ON state, the contact system will be disengaged and the ON state will be broken under certain current conditions) when the pressure at the electrical contact portion 204b inside the upper bifurcated end 202b-1 of the bifurcated contact 20b increases and the pressure at the electrical contact portion 206b inside the lower bifurcated end 202b-2 decreases under the electro-dynamic repulsion force, i.e., F1′>F1, F2′<F2. When the pressure at the electrical contact portion 204b inside the upper bifurcated end 202b-1 of the bifurcated contact 20b decreases and the pressure at the electrical contact portion 206b at the lower bifurcated end 202b-2 increases, i.e., F1′<F1, F2′>F2, the bifurcated contact 20b has a clockwise rotation tendency and the bifurcated contact 20b gets stuck on the movable contact 30, and the contact system is stably connected.

Table 1 shows the effects of the different current distribution ratios of the bifurcated contact 20b on the states of the contact system. When the current of the electrical contact portion 204b inside the upper bifurcated end 202b-1 flowing through the bifurcated contact 20b is calculated to be smaller than the current flowing through the electric contact portion 206b inside the lower bifurcated end 202b-2 of the bifurcated contact 20b, the bifurcated contact 20b and the movable contact 30 will not be separated from each other by the electric-dynamic repulsion force, thereby ensuring stable connection of the contact system.

TABLE 1
the effects of the different current distribution ratios of the bifurcated contact 20b on the
states of the contact system

| Current Distribution: total current I = 8000A | | | | | |
|---|---|---|---|---|---|
| the first distribution | | the second distribution | | | |
| ratio | | ratio | | The third distribution ratio | |
| I₁ = 4000A I₂ = 4000A | $\frac{{I}_{1}}{{I}_{2}} = 1$ | I₁ = 3300A I₂ = 4700A | $\frac{{I}_{1}}{{I}_{2}} = 0.70$ | I₁ = 4700A I₂ = 3300A | $\frac{{I}_{1}}{{I}_{2}} = 1.42$ |

| | | | |
|---|---|---|---|
| the | F1′ > F1 | F1′ < F1 | F1′ > F1 |
| relationship | F2′ < F2 | F2′ > F2 | F2′ < F2 |
| of F1, F2 | | | |
| and | | | |
| F1′, F2′ | | | |
| State of | disconnected | Stably connected | disconnected |
| the | | | |
| contact | | | |
| system | | | |

There are two ways to make the current flowing into the electrical contact portions 204a/204b inside the upper bifurcated ends 202a/b-1 of the bifurcation contacts 20a/b smaller than the current flowing into the electrical contact portions 206a/206b of the lower bifurcated ends 202a-2/b-2 of the bifurcation contacts 20a/b. One way is that with the rotation hole 210a-1/210b-1 as the current inflow/outflow point of the bifurcated contact 20a/20b, changing the size (such as width, height, and thickness) of the two bifurcated ends 202a-1/202b-1 and 202a-2/202b-2 of the U-shaped connecting body of the bifurcation contact 20a/20b, such that the resistance of the upper bifurcated ends 202a-1/202b-1 may be larger than the resistance of the lower bifurcated ends 202a-2/202b-2 of the bifurcated contacts 20a/20b (in the exemplary bifurcated contacts shown in FIGS. 2 and 3, it's achieved by symmetrically providing grooves 202a-1-1/202b-1-1 on both sides of the upper bifurcated ends 202a-1/202b-1). Second way is that the electrical contact portions at both ends of the bifurcated contact 20a/20b can be made with different materials having different resistivity and different contact resistances.

The Holm electro-dynamic repulsion force generated on the electrical contact portion inside the upper bifurcated end of the bifurcated contact is smaller than that on the electrical contact portion inside the lower bifurcated end due to the current distribution function of the bifurcated contact and they can partially offset each other. Considering the Holm electro-dynamic repulsion force (Lorentz force) of the circuit as a whole, the contact system according to the embodiment of the present disclosure can stably maintain in the ON state when a large current such as a short circuit current passes through. The short-time current withstand capability of the low-voltage switch of the contact system according to the embodiment of the present disclosure is greatly improved.

As shown in FIG. 10, when the contact system is switched on, at the contact points, the electrical contact portions inside the bifurcated ends of the bifurcated contact are respectively subjected to the initial pressures F1, F2, which are perpendicular to the respective arc surfaces and directed to the respective arc centers, and also subjected to the Holm forces FH1, FH2 after powered up. With the initial pressures and the Holm forces, the distance between the two bifurcated ends of the bifurcated contact (i.e., the opening of the bifurcated contact) tends to increase. If the stress generated on the bifurcated contact is greater than the yield limit of the material under the initial pressures and the Holm forces, the bifurcated contact will have irreversible plastic deformation. The opening of the bifurcated contact increases gradually with increasing of the number of switching on/off actions. In order to increase the stiffness of the bifurcated contact, the thickness of the bifurcated contact and/or the height of the two bifurcated ends can be increased, or a material having a higher modulus of elasticity may be used. Due to the installation space limitations and economic considerations, there are certain limitations for the first method to improve the stiffness. When the second method is used to increase the stiffness, the U-shaped connecting body 202b is designed as a three-piece combinatory structure (for example, a three-piece welded structure) as shown in FIG. 3 to satisfy the temperature rise requirement. The U-shaped connecting pieces 20a-1, 20a-3 on both sides of the U-shaped connecting body 202b has the same material (for example, copper), and the U-shaped connecting piece 20a-2 in the middle and having an uniform thickness is selected from a material having a higher elasticity modulus, for example, stainless steel.

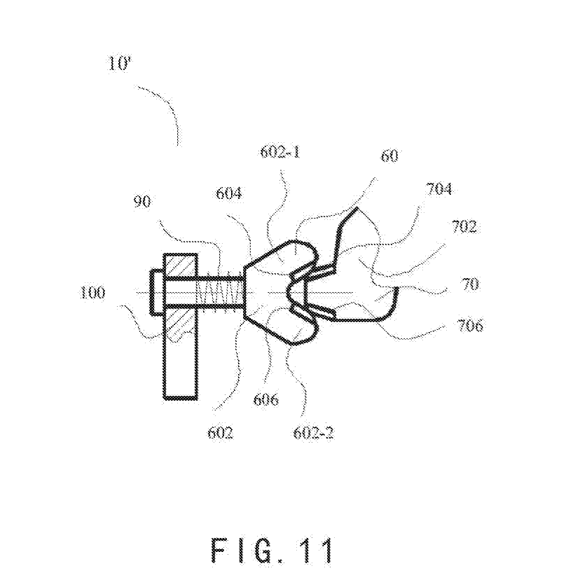

FIG. 11 shows a schematic diagram of the contact system in the ON state according to the third embodiment of the present disclosure. When the contact system 10′ shown in FIG. 11 is used in the low-voltage switch 1 instead of the above-described contact system 10, the short-time current withstand capability of the low-voltage switch 1 can also be greatly improved.

Specifically, as shown in FIG. 11, the contact system 10′ includes a bifurcated contact 60 and a movable contact 70, wherein the bifurcated contact 60 comprises a Y-shaped connecting body 602 and two electrical contacts 604 and 606 inside the bifurcated ends 602-1 and 602-2 of the Y-shaped connecting body 602, respectively. The bifurcated contact 60 may slide on the slideway 90 which is substantially parallel to the bottom surface of the low voltage switch 1 along the direction of the axis of the columnar portion of the Y-shaped connecting body 602.

As shown in FIG. 11, the movable contact 70 includes a rod portion 702 and two electrical contact portions 704 and 706 which are substantially symmetrically distributed at the C-shaped end of the rod portion 702. The other parts of the movable contact 70 are the same as those of the above-described embodiment (see FIGS. 6 and 7). The angle of the planes where the electrical contact portions 704 and 706 are located is an acute angle, so as to facilitate a stable connection of the bifurcated contact 60 with the movable contact 70. The bracket of the slideway 90 of the bifurcated contact 60 is connected to the connection plate 100 by screw connection, rivet connection, welding, etc., so as to fix the bifurcated contact 60 to the housing of the low voltage switch 1.

As shown in FIGS. 1 and 11, when the contact system 10′ shown in FIG. 11 is switched on by the operating mechanism 14 in the low-voltage switch 1, the movable contact 70 is rotated counterclockwise, and the electrical contact 706 of the movable contact 70 first contacts the upper bifurcated end 602-1 of the bifurcated contact 60, the bifurcated contact 60 is moved leftward along the slideway 90 by the action of the movable contact 70, and the movable contact 70 continues to rotate counterclockwise until the electrical contact portions 704 and 706 of the movable contact 70 in contact with the electrical contact portions 604 and 606 of the bifurcated contact 60 to form a stable conductive connection.

As shown in FIG. 11, the execution ends of the bifurcated contact 60 and the movable contact 70 are laterally symmetrical and have a common symmetrical center in the ON state. After switched on and powered up, the currents flowing to the two bifurcated ends 602-1 and 602-2 of the bifurcated contact 60 are equal, and the Holm forces acted on the symmetrical two electrical contacts 604 and 606 of the bifurcated contact 60 are of equal magnitude and symmetrical directions, so that the bifurcated contact 60 and the movable contact 70 can be in a relatively stable connection state, thereby improving the short-time current withstand capability of the low voltage switch 1.

The present disclosure has been described in the above embodiments, but it should be understood that the above-described embodiments are for the purpose of illustrating and explaining only and are not intended to limit the disclosure to the scope of the described embodiments. It will also be understood by those skilled in the art that the present disclosure is not limited to the embodiments described above, various changes and modifications may be made in accordance with the teaching of the disclosure which fall within the scope of the disclosure. The scope of the disclosure is defined by the appended claims and their equivalents.

1. A contact system in a low-voltage switch comprising a bifurcated contact and a movable contact, wherein:
the bifurcated contact has an upper bifurcated end and a lower bifurcated end, wherein electrical contact portions are respectively arranged on insides of the upper bifurcated end and the lower bifurcated end,
electrical contact portions are respectively arranged on upper and lower surfaces of an execution end of the movable contact corresponding to the electrical contact portions of the bifurcated contact,
when the contact system is switched on and powered up, electrodynamic repulsion forces produced at the electrical contact portions of the bifurcated contact are offset, so that the contact system can stably maintain an ON state.

2. The contact system of claim 1, wherein the bifurcated contact is U-shaped or C-shaped, and when the contact system is switched on and powered up, the current flowing through the upper bifurcated end is less than the current flowing through the lower bifurcated end.

3. The contact system of claim 1, wherein the bifurcated contact and the electrical contact portions of the bifurcate contact form an integral structure with homogeneous material.

4. The contact system of claim 1, wherein the parts of the bifurcated contact except for the electrical contact portions are of a combinatory structure with multiple connection pieces in the thickness direction or a monolithic structure, wherein the material of at least one of the multiple connection pieces has a higher elasticity modulus than that of the rest of the multiple connection pieces.

5. The contact system of claim 1, wherein the electrical contact portions of the bifurcated contact or the removal contact are of low contact resistance and are formed of electric arc-resistant material.

6. The contact system of claim 2, wherein the bifurcated contact is arranged with a rotating center hole, current is distributed from the rotating center hole to the upper bifurcated end and the lower bifurcated end, and the resistance of the upper bifurcated end is greater than that of the lower bifurcated end.

7. The contact system of claim 1, wherein all or part of the surfaces of the electrical contact portions of the upper bifurcated end and the lower bifurcated end that face each other are arc surfaces, the arc surfaces are used for electrical contact and making space in the process of connecting or disconnecting the bifurcated contact with the movable contact.

8. The contact system of claim 1, wherein the bifurcated contact is Y-shaped or V-shaped, when the contact system is switched on and powered up, the current flowing through the upper bifurcated end is equal to the current flowing through the lower bifurcated end.

9. The contact system of claim 2, wherein the bifurcated contact is arranged with a restoration structure for restoring the bifurcated contact with the assistance of a restoring spring or clips after the bifurcated contact is disconnected with the removable contact.

10. The contact system of claim 8, wherein the bifurcated contact is arranged with a restoration structure for restoring the bifurcated contact with the assistance of a restoring spring or clips after the bifurcated contact is disconnected with the removable contact.

11. A low-voltage switch comprising a arc-extinguishing chamber, an operating mechanism and a contact system of claim 1.
